(19) United States
(12) Patent Application Publication
(10) Pub. No.: US 2021/0355243 A1
(43) Pub. Date: Nov. 18, 2021

(54) MODIFIED NANOCELLULOSIC MATERIALS FOR CARBON DIOXIDE MITIGATION TECHNOLOGY

(71) Applicant: TUSKEGEE UNIVERSITY, Tuskegee, AL (US)

(72) Inventors: Michael L. Curry, Tuscaloosa, AL (US); Donald H. White, Tuskegee, AL (US)

(21) Appl. No.: 17/321,181

(22) Filed: May 14, 2021

Related U.S. Application Data
(60) Provisional application No. 63/024,821, filed on May 14, 2020.

(51) Int. Cl. C08B 15/00; B01J 20/24; B01D 53/04

(52) U.S. Cl. CPC C08B 15/00; B01J 20/24; B01D 2257/504; B01J 2220/4831; B01D 2253/20; B01D 53/0407

(57) ABSTRACT

A bio-based material including a nanocellulose treated with low-temperature plasma, wherein the bio-based material is capable of sequestering carbon dioxide from an ambient atmosphere. A method is also disclosed.

### PRIORITY TO RELATED APPLICATIONS

This application claims the benefit of U.S. Provisional Application No. 63/024,821 filed May 14, 2020, the entirety of which is incorporated by reference.

### BACKGROUND

Embodiments of the present invention described herein are directed to new bio-based materials that can be used, among other things, to filter, sequester, or otherwise capture carbon dioxide (CO₂) from the atmosphere. For example, disclosed are bio-based materials, methods of making them, and uses for the same. According to one embodiment, the bio-based material comprises modified nanocellulose, which can be used to sequester or mitigate CO₂. The bio-based materials described herein are naturally derived, renewable, environmentally friendly, and have no negative impact on humans.

Carbon dioxide occurs naturally in the atmosphere. It is one of the necessary ingredients for photosynthesis to occur allowing plants to make food and energy. Levels of CO₂ in the atmosphere are higher than they have been at any time in the past 400,000 years. Problems associated with continuously rising levels of CO₂ in the Earth's atmosphere are manifesting themselves in a variety of ways. Rising CO₂ is not just responsible for the rise in global temperature; it also impacts the global food system such as crop yields, plant biodiversity, and ocean acidification, among other things. In addition to the negative impacts on the environment, carbon dioxide emissions impact human health by displacing oxygen in the atmosphere. For example, in closed areas, high levels of carbon dioxide can lead to health complaints such as headaches and even possibly death.

Carbon sequestration describes long-term storage of carbon dioxide or other forms of carbon to either mitigate or defer global warming and avoid dangerous climate change. Various carbon sequestration or carbon mitigation technologies and methods have been explored to help counteract the rising level of CO₂ in the atmosphere, including certain physical processes, chemical processes, and biological processes. For example, one physical carbon mitigation process relates to capturing carbon using biomass in power stations and boilers. Another physical mitigation technique that has been theorized is storing CO₂ in the ocean. This concept involves injecting CO₂ at the ocean floor, where the pressures would be great enough to compress the CO₂ into its liquid phase. In terms of chemical processes, CO₂ may be sequestered and stored in carbonate mineral forms. The technique is generally referred to as mineral sequestration and involves reacting CO₂ with certain metal oxides to form stable carbonates. And various biological carbon mitigation approaches have incorporated farming and foresting methods.

Although there are other materials and devices that have been constructed to measure and capture CO₂, these systems suffer from most of its components consisting of toxic materials itself. Moreover, present CO₂ management projects and technologies concentrate on emission reductions from current operations through energy efficiency improvements, operating practice changes, or process changes. These actions must compete with other investment opportunities within companies and must generate a favorable return on the capital or operating funds invested or else cast aside or deprioritized. The CO₂ mitigation technologies and processes previously developed and currently in use have deficiencies in their efficacy and efficiency, present logistical issues, and are constrained by other factors such as finances. There remains a need, however, for materials and processes that are effective, efficient, renewable, and environmentally friendly. Hence, the development of natural materials capable of capturing and storing CO₂ is essential in order to provide future devices that have no negative impact on the ecosystem and humans.

### SUMMARY

Embodiments disclosed herein fulfill the deficiencies in the art. The embodiments disclosed herein relate to novel bio-based materials, including modified nanocellulose materials, and methods of making the same. The bio-based materials may be suitable for and useful in capturing CO₂ from the ambient atmosphere. The materials may be incorporated into industrial devices, such as filtering devices.

The bio-based material comprises nanocellulose treated with low-temperature plasma, wherein the bio-based material is capable of sequestering carbon dioxide from an ambient atmosphere.

The method comprises applying a nanocellulose material with low temperature plasma to modify the surface of the nanocellulose to provide for the surface of the nanocellulose material being capable of sequestering CO₂ from the atmosphere.

### BRIEF DESCRIPTION OF THE DRAWINGS

A more particular description briefly stated above will be rendered by reference to specific embodiments thereof that are illustrated in the appended drawings. Understanding that these drawings depict only typical embodiments and are not therefore to be considered to be limiting of its scope, the embodiments will be described and explained with additional specificity and detail through the use of the accompanying drawings in which:

FIGS. 1A-1D show images of exemplary nanocellulose treated with low temperature plasma over varying periods of time;

FIG. 2 shows the result of an ATR spectroscopy of an untreated nanocellulose sample and four treated nanocellulose samples;

FIG. 3 shows a plot of the amount of C═C surface functionalization for an untreated nanocellulose sample and four treated nanocellulose samples;

FIG. 4 is a plot showing the inverse relationship between the pH of treated nanocellulose samples and CO₂ absorbance of the same;

FIG. 5 is a plot showing the relationship between pH of treated nanocellulose samples and the samples' sequestration of ambient CO₂; and

FIG. 6 shows the result of an FTIR analysis of treated nanocellulose samples after being placed in water for a period sufficient to allow for the release of CO₂ from the nanocellulose samples into the water.

### DETAILED DESCRIPTION

Embodiments are described herein with reference to the attached figures wherein like reference numerals are used throughout the figures to designate similar or equivalent elements. The figures are not drawn to scale and they are provided merely to illustrate aspects disclosed herein. Several disclosed aspects are described below with reference to non-limiting example applications for illustration. It should be understood that numerous specific details, relationships, and methods are set forth to provide a full understanding of the embodiments disclosed herein. One having ordinary skill in the relevant art, however, will readily recognize that the disclosed embodiments can be practiced without one or more of the specific details or with other methods. In other instances, well-known structures or operations are not shown in detail to avoid obscuring aspects disclosed herein. The embodiments are not limited by the illustrated ordering of acts or events, as some acts may occur in different orders and/or concurrently with other acts or events. Furthermore, not all illustrated acts or events are required to implement a methodology in accordance with the embodiments.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements. Furthermore, unless otherwise clear from the context, a numerical value presented herein has an implied precision given by the least significant digit. Thus, a value 1.1 implies a value from 1.05 to 1.15. The term “about” is used to indicate a broader range centered on the given value, and unless otherwise clear from the context implies a broader range around the least significant digit, such as “about 1.1” implies a range from 1.0 to 1.2. If the least significant digit is unclear, then the term “about” implies a factor of two, e.g., “about X” implies a value in the range from 0.5X to 2X, for example, about 100 implies a value in a range from 50 to 200. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

Nanotechnology is an ever-expanding field of science that encompasses the synthesis, characterization, and use of nano-scale materials. Nanomaterials display unique physical and chemical properties that make them ideal for a wide array of applications, such as in certain biological systems. An increased interest has developed in renewable polymers and bio-based materials. Nanocellulose is one such material. It is pseudo-plastic and possesses advantageous properties that can be found in specific kinds of fluids or gels, including being lightweight, stiff, non-toxic, and, notably, gas impermeable. The raw material, cellulose, is one of, if not the most, abundant polymers on earth. Nanocellulose already has a wide range of applications, from cleaning of oil spills to usage in children's toys. Nanocellulose can be used in pharmaceutical, food and medical industries.

As discussed herein, embodiments provide for a bio-based material comprising nanocellulose treated with low-temperature plasma, wherein the bio-based material is capable of sequestering carbon dioxide from an ambient atmosphere.

The embodiments also provide the above bio-based material, wherein the bio-based material is derived entirely from natural and renewable materials.

The embodiments also provide for the above bio-based materials, wherein the nanocellulose is treated with low-temperature plasma having electron energies less than 15 eV.

Embodiments also provide for the above bio-based materials, wherein the nanocellulose is treated with low-temperature plasma for five minutes or longer.

The application provides the above bio-based materials, wherein a modified nanocellulose surface is created upon the nanocellulose being treated with the low-temperature plasma.

The application provides the above bio-based materials, wherein the modified nanocellulose surface sequesters carbon dioxide from the ambient atmosphere.

The application further provides a filter device comprising any one of the above bio-based materials.

The present invention relates to bio-based materials that are suitable for capturing CO₂ from the ambient atmosphere. Such materials can be incorporated into industrial devices such as filtering devices. Exemplary bio-based materials include surface-modified nanocellulose materials.

According to certain embodiments, the bio-based material capable of sequestering CO₂ comprises modified nanocellulose material. More specifically, the surface of the nanocellulose is modified by being exposed to, or treated with, low temperature plasma (“LTP”). Plasma temperature is commonly and generally a measure of the thermal kinetic energy. A threshold level of kinetic energy is required to sustain ionization, a defining property of plasma. Otherwise, without ionization, ions and electrons combine or are bound into atoms and plasma will convert into gas. LTP thus broadly represents a state of plasmas composed of neutral atoms and molecules, radicals, excited states, ions and electrons. LTPs typically have characteristic electron energies ranging from approximately a few eV to 10 eV, with ionization degrees that are typically small, but can reach tens of percent in arc discharges.

An LTP treatment on nanocellulose material may be conducted by a variety of plasma systems, with a variety of system configurations. One exemplary system is a PE-100 desktop plasma laboratory system. Such system consists of tumbler chamber (e.g., 34.2 L volume, although chamber volume may vary depending on scale and amount of cellulose to be treated), with a three stacked horizontal electrode configuration. Cellulose nanofibrils are placed in the tumbler chamber for specified lengths of time. The cellulose nanofibrils can be treated anywhere from about 5 minutes to 120 minutes, plus or minus 10 to 20 minutes. During LTP treatment, oxygen gas of high level of purity (98 percent to 100 percent) may be pumped into the tumbler chamber at a flow rate of about 10 parts per minute (“ppm”) up to and including about 50 ppm, plus or minus 10 ppm, or at a flow rate of about 15 ppm up to and including about 30 ppm, plus or minus 10 ppm. According to certain embodiments, the flow rate of oxygen gas is kept constant during LTP treatment (e.g., at approximately 40 cm³/min, plus or minus 10 cm³/min). Tumbler chamber pressure may also be fixed, according to certain embodiments (e.g., at a pressure from about 0.2 bar up to and including about 0.6 bar plus or minus 0.3 bar).

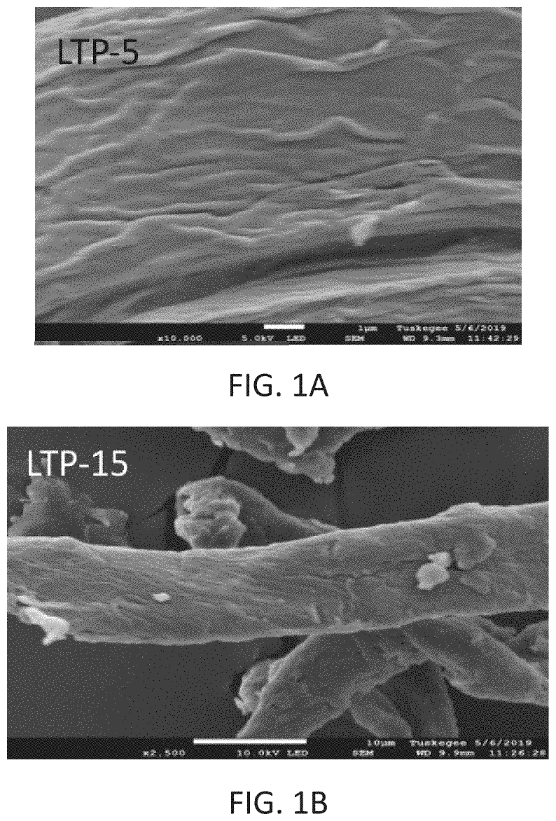

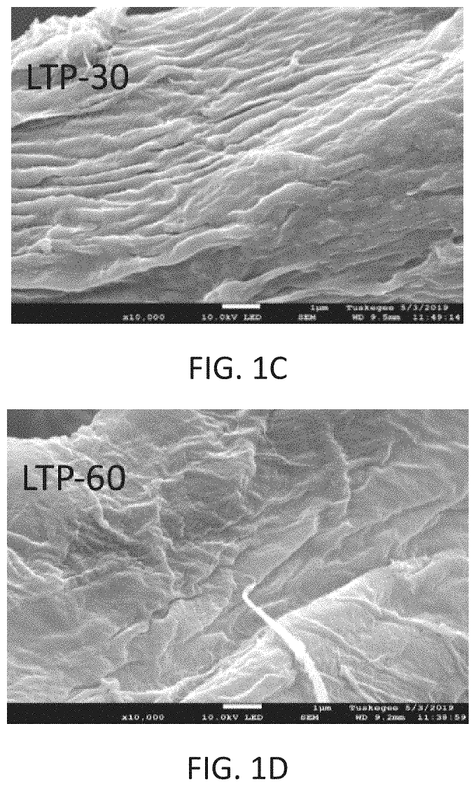

Such treatment produces nanocellulose material wherein the surface-level carbon nanofibers (“CNF”) are capable of sequestering CO₂. The surface structure of nanocellulose evolves over the course of time while being treated with low temperature plasma. This evolution is illustrated in FIGS. 1A-1D. For example, FIG. 1A is an image of the surface of nanocellulose after being treated with low temperature plasma for five minutes. FIG. 1B is an image of the surface of nanocellulose after being treated with low temperature plasma for 15 minutes. FIG. 1C is an image of the surface of nanocellulose after being treated with low temperature plasma for 30 minutes. FIG. 1D is an image of the surface of nanocellulose after being treated with low temperature plasma for 60 minutes.

All images in FIGS. 1A-1D were captured by a scanning electron microscope (“SEM”). FIGS. 1A-1C show series of waved ridges on the nanocellulose surface. These ridges indicate the intricate network of individual nanofibers, and it is this intricate network of nanofibers that allows the nanocellulose surface to sequester CO₂ from the atmosphere. FIG. 1D shows more of a web-like topography, indicating an even further developed and intricate network of nanofibers.

To illustrate the benefits and advantages of the biomaterials and methods described above, exemplary nanocellulose materials were created and tested. The testing of exemplary treated nanocellulose materials described below is offered to aid in understanding the present invention and its uses and practical advantages. Accordingly, various samples of nanocellulose materials were created for empirical testing. Untreated nanocellulose (“NEAT-CNF”) was tested in certain instances as a control. Other nanocellulose samples were created by treating the nanocellulose material with low temperature plasma for various periods of time—e.g., for five minutes (“LTP-5”), for 15 minutes (“LTP-15”), for 30 minutes (“LTP-30”), and for 60 minutes (“LTP-60”).

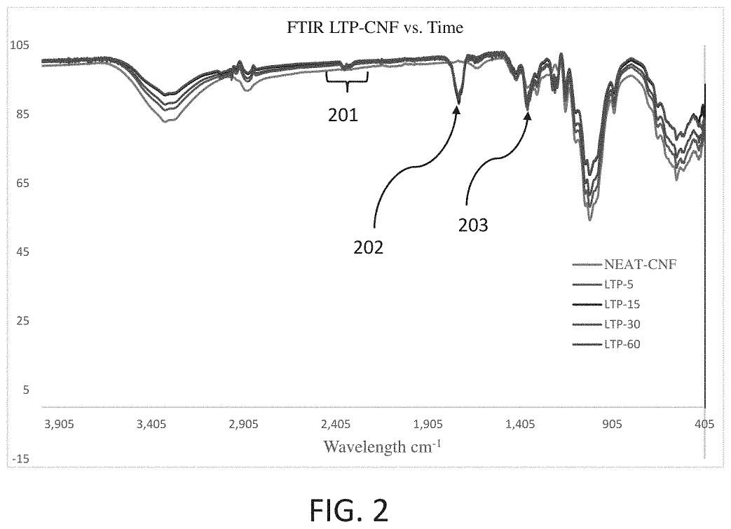

FIG. 2 shows the result of an ATR spectroscopy of an untreated nanocellulose sample and four treated nanocellulose samples. The spectroscopy was prepared by acid hydrolysis using sulfuric acid (H₂SO₄). The peak 202 in FIG. 2 shows the emergence of a carbon-carbon double bond (C═C). The peak 203 corresponds to the out of phase bending of carbonate (CO₃²⁻). The peak 201 represents the doublet stretching of CO₂ at a wavelength of approximately 2355 cm⁻¹. The untreated nanocellulose sample (NEAT-CNF) noticeably lacks a peak at arrow (A.), which indicates the absence of C═C and thus a lack of CO₂ capture.

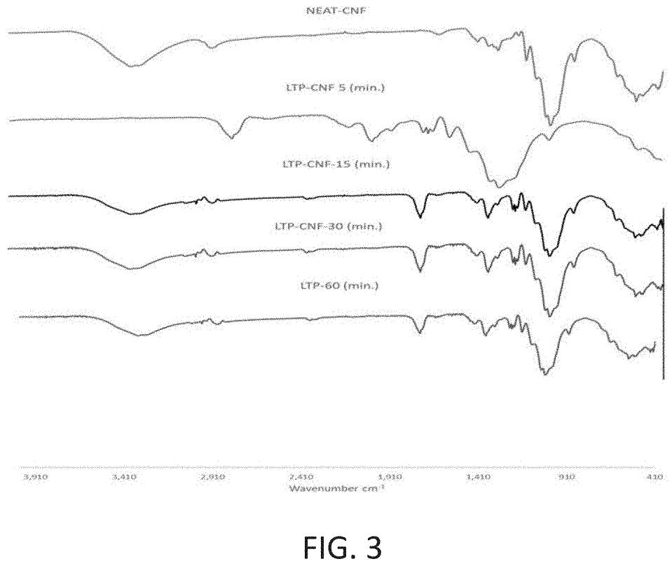

It has been discovered that the degree to which a modified nanocellulose material can sequester or capture CO₂ is proportionate to the length of time that the nanocellulose material is treated with low temperature plasma. FIG. 3 illustrates various nanocellulose materials that have each been treated with low temperature plasma for different periods of time (5 minutes, 15 minutes, 30 minutes, and 60 minutes), as well as a “Neat” CNF. FIG. 2 is the result of running ATR spectroscopy for the different modified cellulose samples. As can be seen, the peak in the NEAT-CNF sample shifts over time, indicating a transformation in the structure and formation of the nanocellulose material.

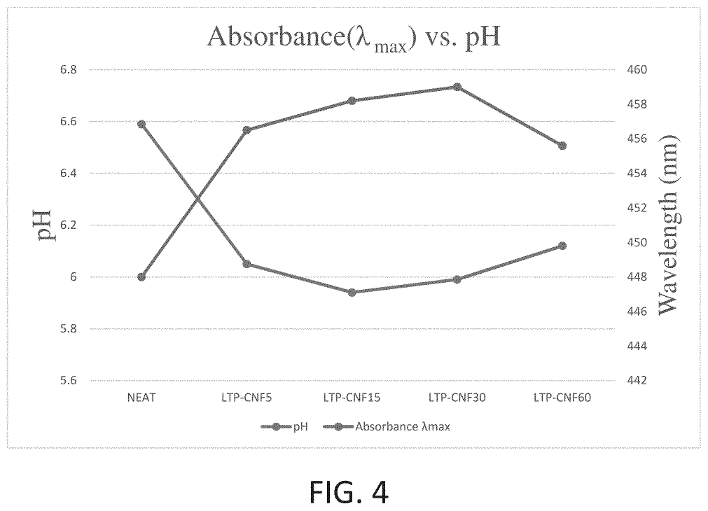

The efficacy of CO₂ capture is empirically quantifiable. For example, when modified nanocellulose (e.g., treated with LTP) is submerged into water, the captured CO₂ is released. FIG. 4 illustrates this: it is a plot showing trends in the measured pH (based on amount of carbonic acid formed via release of captured CO₂) after the emergence of LTP treated nanocellulose in water versus the absorbance intensity of the carbon-carbon double bond as a function of LTP treatment exposure time.

As shown in FIG. 3, the amount of C═C surface functionalization increases with LTP exposure time but reaches a maximum absorbance at LTP exposure time around 15 minutes. This could indicate that the maximum amount of surface functionalization has been achieved since functionalization only occurs to the accessible C6 carbon of the cellulose. If CO₂ sequestering is happening due to the LTP functionalization of the nanocellulose surface with C═C groups, then as the amount of the C═C functionalization increases, the amount of CO₂ should increase. Accordingly, the amount of carbonic acid formed once LTP-treated samples are emerged in water should also increase, causing the pH to be lowered. In fact, it is expected that the pH should inversely track the absorbance intensity of the C═C functional groups formed on the surface of the treated nanocellulose.

As can be observed from FIG. 4, the pH inversely tracks the absorbance intensity exactly. This corresponds to the uptake of CO₂ and the release of carbonic acid. The respective pH change shows a rise in acidity (decrease in pH) as CO₂ is released in water to form carbonic acid. This indicates that the treated nanocellulose indeed sequestered quantifiable amounts of CO₂ and the efficacy of the LTP treatment process is positive.

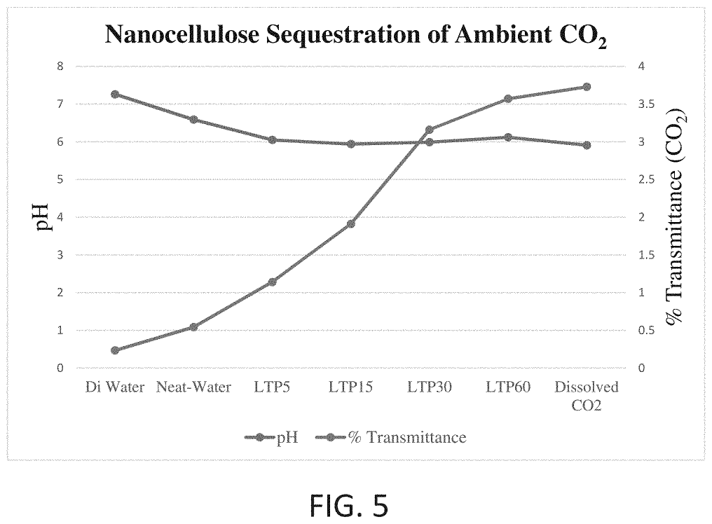

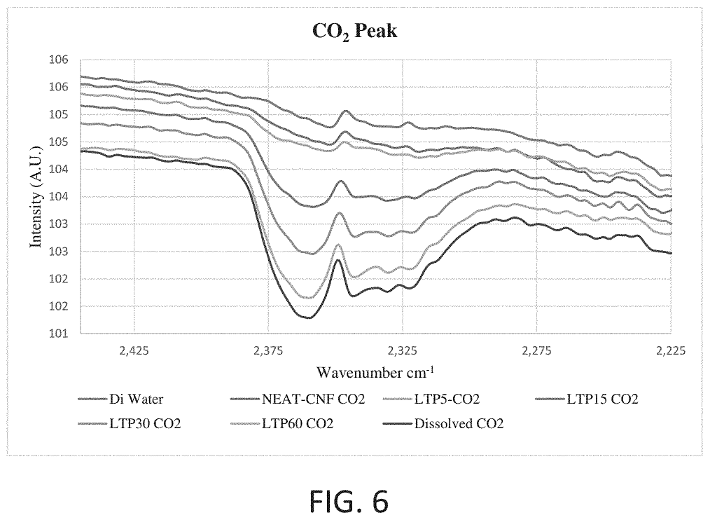

The release of sequestered CO₂ upon submerging treated nanocellulose into water is further illustrated by the plot in FIGS. 5-6. FIG. 5 further illustrates the treated nanocellulose samples' sequestration of ambient CO₂. The plot in FIG. 5 is derived from emerging the treated nanocellulose samples into water. The pH of deionized (DI) water is shown to increase for each of four test samples of treated nanocellulose (a 5 minute LTP treated sample, a 15 minute LTP treated sample, a 30 minute LTP treated sample, and a 60 minute LTP treated sample). The plot shows that as the pH of the water decreases, the doublet peak, or percentage transmittance of CO₂, increases.

Lastly, FIG. 6 is a plot derived from running an FTIR of the water used to extract CO₂ from the nanocellulose samples. After the LTP-treated nanocellulose samples were placed into water for a period sufficient to allow for the release of CO₂ from the nanocellulose samples into the water, the aqueous layer of the dispersion was removed and analyzed to determine the amount of CO₂ that was actually released by the sample. As noted above in reference to FIG. 2, doublet stretching of CO₂ occurred at a wavelength of approximately 2355 cm⁻¹. In FIG. 6, it can be seen that the intensity spikes for each of the LTP-treated nanocellulose samples at that corresponding wavelength. This region (where the spikes appear) is where the vibrational frequency appears for CO₂. Intensity increases as the time treated increases, showing more CO₂ capture for longer-treated samples. These spikes occur when nanocellulose samples are placed in water, and thus CO₂ is released into the water, which directly indicates how much CO₂ was sequestered from the air by the treated nanocellulose samples in the first place.

Thus, as disclosed above, nanocellulose may be treated, or modified, by applying or contacting it with low temperature plasma. The treatment modifies the surface of the nanocellulose, whereby the modified surface is capable of sequestering CO₂ from the atmosphere. Variability in the low temperature plasma treatment can affect the degree to which the modified surface of the nanocellulose captures CO₂. As described above in more detail, it has been discovered that there is a direct relationship between the low temperature plasma treatment and degree of CO₂ sequestration. Carbon dioxide captured and stored on the surface of modified nanocellulose material may be released by submerging the modified nanocellulose material into water. Embodiments of the modified nanocellulose materials and methods of making the same are also described herein.

The terminology used herein is for the purpose of describing particular embodiments only and is not intended to be limiting. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof are used in either the detailed description and/or the claims, such terms are intended to be inclusive in a manner similar to the term “comprising.” Moreover, unless specifically stated, any use of the terms first, second, etc., does not denote any order or importance, but rather the terms first, second, etc., are used to distinguish one element from another. As used herein the expression “at least one of A and B,” will be understood to mean only A, only B, or both A and B.

While various disclosed embodiments have been described above, it should be understood that they have been presented by way of example only, and not limitation. Numerous changes, omissions and/or additions to the subject matter disclosed herein can be made in accordance with the embodiments disclosed herein without departing from the spirit or scope of the embodiments. Also, equivalents may be substituted for elements thereof without departing from the spirit and scope of the embodiments. In addition, while a particular feature may have been disclosed with respect to only one of several implementations, such feature may be combined with one or more other features of the other implementations as may be desired and advantageous for any given or particular application. Furthermore, many modifications may be made to adapt a particular situation or material to the teachings of the embodiments without departing from the scope thereof.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

Therefore, the breadth and scope of the subject matter provided herein should not be limited by any of the above explicitly described embodiments. Rather, the scope of the embodiments should be defined in accordance with the following claims and their equivalents.

1. A bio-based material comprising nanocellulose treated with low-temperature plasma, wherein the bio-based material is capable of sequestering carbon dioxide from an ambient atmosphere.

2. The bio-based material of claim 1, wherein the bio-based material is derived entirely from natural and renewable materials.

3. The bio-based material of claim 1, wherein the nanocellulose is treated with low-temperature plasma having electron energies less than 15 eV.

4. The bio-based material of claim 1, wherein the nanocellulose is treated with low-temperature plasma for at least five minutes.

5. The bio-based material of claim 1, wherein a modified nanocellulose surface is created upon the nanocellulose being treated with the low-temperature plasma.

6. The bio-based material of claim 5, wherein the modified nanocellulose surface sequesters carbon dioxide from the ambient atmosphere.

7. The bio-based material of claim 1, wherein the low-temperature plasma is provided by a tumbler chamber with a three stacked horizontal electrode configuration.

8. The bio-based material of claim 7, wherein the low-temperature plasma provides for an oxygen gas of high level of purity into the tumbler chamber.

9. The bio-based material of claim 8, wherein the oxygen gas is provided at a flow rate of about 10 parts per minute (“ppm”) up to and including about 50 ppm.

10. The bio-based material of claim 8, wherein a flow rate of the oxygen gas is maintained at a constant rate.

11. The bio-based material of claim 10, wherein the constant rate of oxygen gas is about 40 cm³/min.

12. The bio-based material of claim 7, wherein a pressure within the tumbler chamber is at a pressure from about 0.2 bar up to and including about 0.6 bar.

13. A filter device comprising the bio-based material of claim 1.

14. A method, the method comprising applying a nanocellulose material with low temperature plasma to modify the surface of the nanocellulose to provide for the surface of the nanocellulose material being capable of sequestering CO₂ from the atmosphere.

15. The method of claim 14, applying the nanocellulose material with low temperature plasma further comprises applying the low temperature plasma with a tumbler chamber.

16. The method of claim 15, further comprising applying the nanocellulose material within the tumbler chamber from about 5 minutes to 120 minutes.

17. The method of claim 14, further comprising providing an oxygen gas of high level of purity with the low temperature plasma.
